(19) United States
(12) Patent Application Publication
(10) Pub. No.: US 2026/0164465 A1
(43) Pub. Date: Jun. 11, 2026

(54) METHODS AND APPARATUS FOR ENABLING TWO TIMING ADVANCES IN WIRELESS COMMUNICATION

(71) Applicant: APPLE INC., Cupertino, CA (US)

(72) Inventors: Hong HE, San Jose, CA (US); Chunxuan YE, San Diego, CA (US); Dan WU, Beijing (CN); Dawei ZHANG, Saratoga, CA (US); Haitong SUN, Cupertino, CA (US); Huaning NIU, San Jose, CA (US); Wei ZENG, Saratoga, CA (US)

(21) Appl. No.: 18/709,401

(22) PCT Filed: May 11, 2023
(86) PCT No.: PCT/CN2023/093473

§ 371 Date: May 10, 2024

(51) Int. Cl. H04W 74/0833; H04L 5/00; H04W 56/00; H04W 74/00

(52) U.S. Cl. CPC H04W 74/0833; H04L 5/0053; H04W 56/0045; H04W 74/006

(57) ABSTRACT

Disclosed are methods, systems, and computer-readable medium to perform operations including: methods and systems for latency reduction in user equipment (UE) for inter-cell mobility. In one example, a method is disclosed for receiving, at a user equipment (UE), configuration data specifying that a random access response (RAR) window that is started at the first symbol of an earliest type-1 physical downlink control channel (PDCCH) monitoring occasion (MO), wherein a time gap between a physical random access channel (PRACH) transmission and the earlier type-1 PDCCH MO is at least ‘k_{B}’ symbols or slots or million seconds. The method includes transmitting, based on the configuration data, the PRACH transmission, and monitoring, within the RAR window specified by the configuration, each type-1 PDCCH MOs for RAR reception in response to the PRACH transmission.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

The instant disclosure describes methods and systems for latency reduction in user equipment (UE) for inter-cell mobility. In accordance with one aspect of the present disclosure, a method includes, receiving, at a user equipment (UE), configuration data specifying that a random access response (RAR) window is initiated at a type-1 physical downlink control channel (PDCCH) monitoring occasion (MO), wherein a time gap between a physical random access channel (PRACH) transmission. The method further includes, transmitting, based on the configuration data, the PRACH transmission.

In some implementations of the method, a length of the RAR window allows RAR forwarding from a target cell to a serving cell.

In some implementations of the method, the configuration data is provided based on radio resource control (RRC) signaling.

In some implementations of the method, the configured data specify a number of symbols for a type-1 PDCCH common search space (CSS).

In another aspect of the disclosure, a method includes, receiving, at a user equipment (UE), a random access response (RAR), the RAR comprising configuration data specifying a timing advance group (TAG) identifier (TAG-ID) indicative of at least two candidate cells and a respective timing advance (TA) value for each of the at least two candidate cells. The method additionally includes, transmitting, to at least one of the candidate cells indicated by the TAG-ID and based on the TA value for the at least one of the candidate cells, uplink data.

In some implementations, the method includes, receiving, at a user equipment (UE), data indicative of a timing advance group identity (TAG-ID) configured to apply a timing advance value of a random access response (RAR); and receiving, at the UE, data indicative of one or more medium access control-control elements (MAC-CEs) indicating two or more timing advances (TAs) for two or more candidate cells in a single RAR medium access control-control element (MAC-CE).

In some implementations, the method proceeds by, receiving, at a user equipment (UE), data indicative of a timing advance group identity (TAG-ID) configured to apply a timing advance value of a random access response (RAR). In response to receiving the TAG-ID, the method includes, receiving, at the UE, data having instructions to divide one or more control resource set (CORESET) groups into different groups utilizing the TAG-ID associated with each CORESET group of the one or more CORESET groups.

In another aspect of the disclosure, a method includes receiving, at a user equipment (UE), data indicative of a timing advance group (TAG) indication that determines a TAG identity (TAG-ID) to apply a timing advance value of a random access response (RAR). The method additionally includes receiving, at the UE, data indicative of at least one of a TAG-ID, Physical Cell ID, or a dedicated logic ID of a target candidate cell via a DCI format 1_0 having cyclic redundancy check (CRC) scrambled by random access-radio network temporary identifier (RA-RNTI), or having the CRC scrambled by MsgB-RNTI.

In some aspects, a method includes receiving, at a user equipment (UE), data indicative of a timing advance group (TAG) indication that determines a TAG identity (TAG-ID) to apply a timing advance value of a random access response (RAR). The method further includes receiving, at the UE, a UL Grant field or temporary C-RNTI field, data indicative of an enhanced RAR MAC configured to indicate at least one of a TAG identity (TAG-ID), or physical cell ID, or logic ID, of a candidate cell.

In another aspect of the disclosure, a method disclosed herein includes transmitting, from a user equipment (UE), data indicative of a physical random access channel (PRACH) transmission. Additionally, the method includes receiving, at the UE and responsive to the PRACH transmission, a medium access control (MAC) control element (CE) that includes a timing advance (TA) command, the MAC CE further specifying a timing advance group identify (TAG-ID) or physical cell ID of a cell.

In some implementations of the disclosure, the MAC CE is received based on a downlink control information (DCI) format 1_0 having a cyclic redundancy check (CRC).

In some implementations, the CRC is scrambled by a cell-radio network temporary identifier (C-RNTI) during a random access response (RAR) window.

In some implementations, the method proceeds by receiving, at the UE, data indicative of a medium access control protocol data unit (MAC PDU) scheduled by the DCI format 1_0, wherein the MAC PDU comprises an enhanced absolute timing advance (TA) command, medium access control-control element (MAC-CE), that is associated with a target candidate cell or a target a transmission/reception point (TRP).

In some aspects of the disclosure, a method includes transmitting, by a base station, data indicative of an indication, by one or more radio resource control (RRC) parameters, the indication having a first set of physical random access channel (PRACH) resources and a second set of PRACH resources for a user equipment (UE), the first set of PRACH resources specifying a first timing advance (TA) for the UE and the second set of PRACH resources specifying a second TA for the UE. In addition, the method includes obtaining, by the base station, data indicative of a timing advance (TA) for a transmission/reception point (TRP).

In some implementations, the first set of PRACH resources include a first synchronization signal block (SSB) group and a second SSB group, wherein a grouping configuration of the SSB is provided by one or more of a system information block (SIB) information or a radio resource control (RRC) message.

In some implementations of the disclosure, the first set of PRACH resources include a first set of preambles and wherein the second set of PRACH resources include a second set of preambles.

In at least one aspect of the disclosure, a method proceeds by transmitting, by a cell, data indicative of a physical radio access channel (PRACH) resource, wherein the PRACH resource includes a first group and a second group. The method also includes, obtaining, by the cell, data indicative of a tracking area (TA) for a transmission/reception point (TRP).

In another aspect of the disclosure, a processor of a user equipment (UE) is configured to perform operations that include receiving, at the user equipment (UE), configuration data specifying that a random access response (RAR) window that is started at a first symbol of an earliest type-1 physical downlink control channel (PDCCH) monitoring occasion (MO), wherein a time gap between a physical random access channel (PRACH) transmission and the earlier type-1 PDCCH MO is at least ‘k_{B}’ symbols or slots or million seconds. The operations include transmitting, based on the configuration data, the PRACH transmission. The operations also include monitoring, within the RAR window specified by the configuration, each type-1 PDCCH MOs for RAR reception in response to the PRACH transmission.

Another aspect of the disclosure is directed to a processor of a user equipment (UE) that is configured to perform operations that include receiving, at the user equipment (UE), a random access response (RAR), the RAR comprising configuration data specifying a timing advance group (TAG) identifier (TAG-ID) indicative of at least two candidate cells and a respective timing advance (TA) value for the TAG that is identified by the TAG-ID. The operations include transmitting, to at least one of the candidate cells associated with the TAG-ID based on the TA value of the TAG corresponding to the TAG-ID, uplink data.

In yet another aspect, the disclosure describes a processor of a user equipment (UE) that is configured to perform operations including: receiving, at the user equipment (UE), data indicative of a timing advance group identity (TAG-ID) for a candidate cell to indicate a timing advance value for uplink transmission on the candidate cell. The operations further include receiving, at the UE, data indicative of at least one of a TAG-ID, Physical Cell ID, or a dedicated logic ID of a target candidate cell via a DCI format 1_0 having cyclic redundancy check (CRC) scrambled by random access-radio network temporary identifier (RA-RNTI), or having the CRC scrambled by MsgB-RNTI where the DCI format 1_0 consists of one field indicating a TAG-ID or Physical Cell ID or a dedicated logic ID of a target candidate cell.

Another aspect of the disclosure describes a processor of a user equipment (UE) that is configured to perform operations that includes receiving, at the user equipment (UE), data indicative of a timing advance group (TAG) for a candidate cell to apply a timing advance value of a random access response (RAR). The operations include receiving, at the UE, an enhanced RAR MAC repurposing a UL Grant field or temporary C-RNTI field to indicate at least one of a TAG identity (TAG-ID), or physical cell ID, or logic ID, of a candidate cell.

Yet another aspect of the disclosure describes a processor of a user equipment (UE) that is configured to perform operations that includes transmitting, from the user equipment (UE), data indicative of a physical random access channel (PRACH) transmission, and receiving, at the UE and responsive to the PRACH transmission, a medium access control (MAC) control element (CE) that includes a timing advance (TA) command, the MAC CE further specifying a timing advance group identify (TAG-ID) or physical cell ID of a candidate cell to apply the TA value indicated by the TA command of the MAC-CE.

At least one aspect of the disclosure describes a processor of a base station that is configured to perform operations that include transmitting, by the base station, data indicative of an indication, by one or more radio resource control (RRC) parameters, the indication having a first set of physical random access channel (PRACH) resources and a second set of PRACH resources for a user equipment (UE), the first set of PRACH resources are used to obtain a first timing advance (TA) associated with a first TAG-ID for the UE and the second set of PRACH resources are used to obtain a second TA associated with a second TAG-ID for the UE. The operations include obtaining, by the base station, data indicative of a timing advance (TA) for a transmission/reception point (TRP).

Another aspect of this disclosure describes a processor of a cell that is configured to perform operations that include transmitting, by the cell, data indicative of a physical radio access channel (PRACH) resource configuration, wherein the PRACH resources indicated by the configuration includes a first group of PRACH resources and a second group of PRACH resources. The operations include obtaining, by the cell, data indicative of a tracking area (TA) for a transmission/reception point (TRP).

In some implementations of the disclosure, a non-transitory computer storage medium encoded with instructions that, when executed by one or more computers, cause the one or more computers to perform any one of the methods described above.

In some implementations, a system includes one or more processors and one or more storage devices on which are stored instructions that are operable, when executed by the one or more processors, to cause the one or more processors to perform any one of the methods described above.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates a schematic showing a user equipment (UE) receiving a transmission from a serving cell configured to transmit information to one or more candidate cells.

FIG. 3 illustrates a schematic for an RAR window, received at the UE of FIG. 2, which is configured to specify a timing advance group identifier (TAG-ID).

FIG. 4 illustrates a schematic for a UE header that indicates an RAR that is configured to indicate a given TAs for an associated candidate cell.

FIG. 5 shows a UE header having a plurality of blocks that are configured to support multiple TAs for more than one candidate cell.

FIG. 6 illustrates a schematic for a plurality of CORESET groups having corresponding TAG-IDs.

FIG. 7 illustrates a UE header of a TA command for indicating a TAG-ID.

FIG. 8 illustrates a process 800 for a RACH procedure used to obtain one or more TAs at the UE, shown in FIG. 2.

FIGS. 9A-9B illustrate a schematic of a mechanism to enable two TAs for intra-cell intra-cell multi-transmission reception point (mTRP) transmission.

FIG. 10 illustrates a flowchart of an example method, according to some implementations.

FIG. 11 illustrates a flowchart of an example method, according to some implementations.

FIG. 12 illustrates a flowchart of an example method, according to some implementations.

FIG. 13 illustrates a flowchart of an example method, according to some implementations.

FIG. 14 illustrates a flowchart of an example method, according to some implementations.

FIG. 15 illustrates a flowchart of an example method, according to some implementations.

FIG. 16 illustrates a flowchart of an example method, according to some implementations.

FIG. 17 illustrates an example user equipment (UE), according to some implementations.

FIG. 18 illustrates an example access node, according to some implementations.

### DETAILED DESCRIPTION

The instant disclosure describes methods and systems for latency reduction in user equipment (UE) for inter-cell mobility. New mobile services that require low-latency and high reliability performance (e.g., URLLC) are emerging. In current NR design, the physical radio access channel (PRACH) reception and a random access response (RAR) transmission are performed by a single gnodeB (gNB). One aspect of this disclosure describes uplink timing enhancement that specifies methods and systems for layer 1 (L1)/layer 2 (L2) based inter-cell mobility (LTM) for mobility latency reduction, as well as timing advance management in radio layer 1 (RAN1) and radio layer 2 (RAN2).

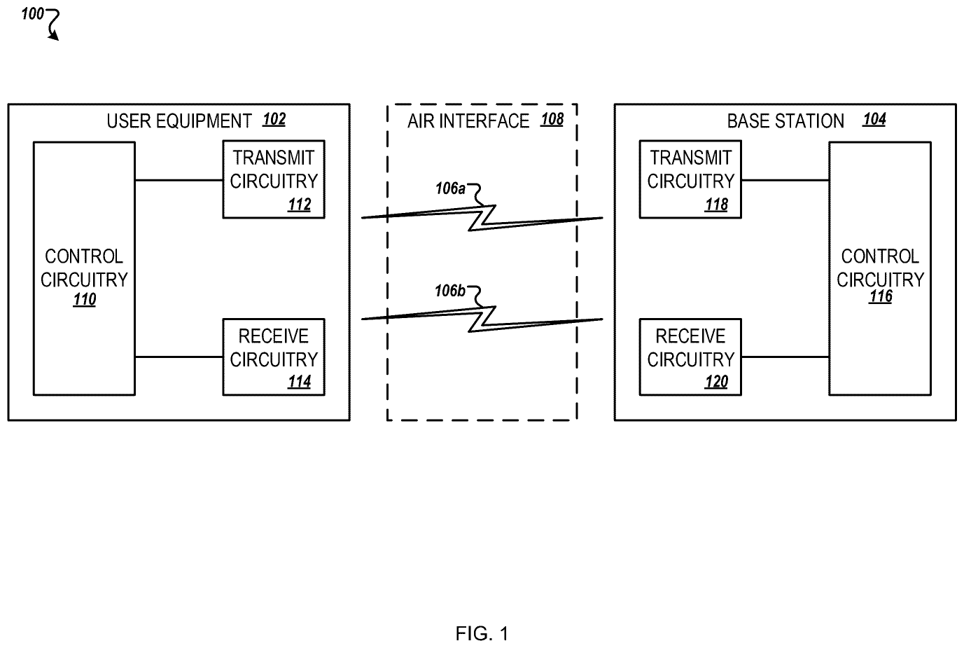

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE. For instance, the control circuitry 110 can perform each one of the receiving operations described above with respect to the methods, such as receiving, at a user equipment (UE), configuration data specifying that a random access response (RAR) window is initiated at a type-1 physical downlink control channel (PDCCH) monitoring occasion (MO).

The transmit circuitry 112 can perform various operations described in this specification. For example, the transmit circuitry 112 can performing any one of the transmitting operation described above, including transmitting, to at least one of the candidate cells indicated by the TAG-ID and based on the TA value for the at least one of the candidate cells, uplink data. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can perform any one of the receiving operation described above, including receiving, at a user equipment (UE), a random access response (RAR), the RAR comprising configuration data specifying a timing advance group (TAG) identifier (TAG-ID) indicative of at least two candidate cells and a respective timing advance (TA) value for each of the at least two candidate cells. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

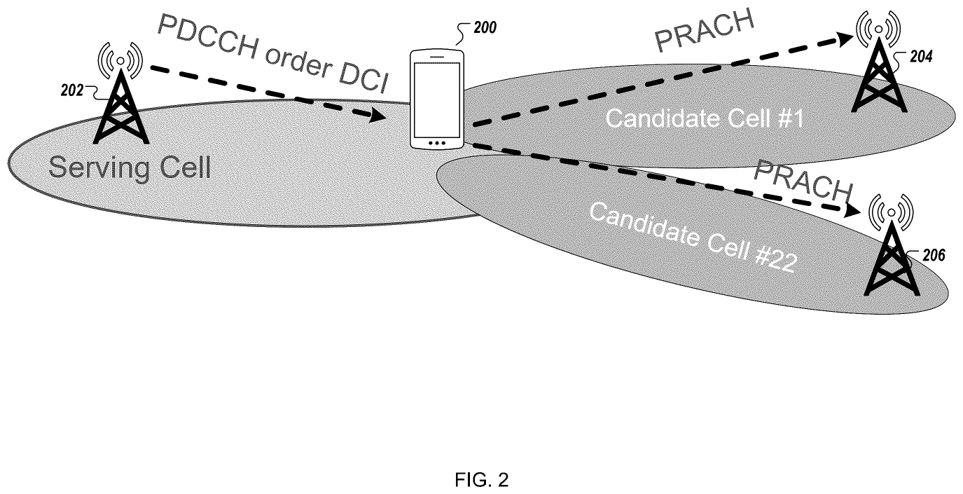

FIG. 2 illustrates a schematic showing a user equipment (UE) 200 receiving a transmission from a serving cell configured to transmit information to one or more candidate cells. For example, the UE 200 receives configuration data specifying that a random access response (RAR) window, which advantageously reduces UE power consumption for a type-1 physical downlink control channel (PDCCH) monitoring occasion (MO).

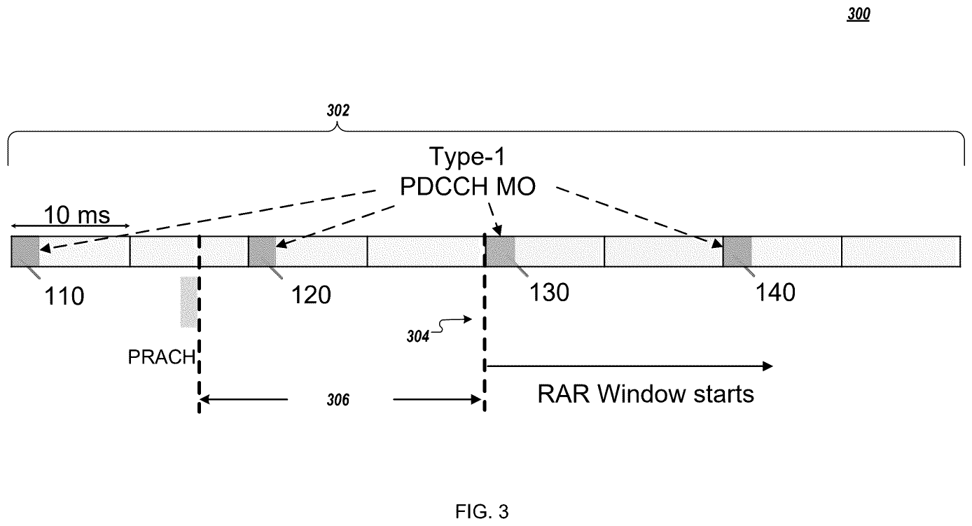

FIG. 3 illustrates a schematic for an RAR window 300, received at the UE 200, which is configured to specify a timing advance group identifier (TAG-ID). When the RAR window 300 is configured for a contention free random access (CFRA) procedure of a candidate cell (e.g., candidate cell 204 or candidate cell 206), once the Random Access Preambles is transmitted towards a target candidate cell, the UE 200 attempts to detect a DCI format 1_0. The DCI format 1_0 a cyclic redundancy check (CRC) that is scrambled by a cell-radio network temporary identifier (C-RNTI) during a random access response (RAR) window from the serving cell 202.

In some implementations, the RAR window 300 starts at position 302 that is the first symbol of the earlier CORESET the UE is configured to monitor a type-1 PDCCH common search channel (CSS) set that is at least k_{B} symbols, msec, or slots 302. In some legacy systems, the PRACH is received at the UE 200 by a target gNB and the corresponding RAR is forwarded to the serving gNB over a backhaul link, which can take tens of milliseconds to complete. In contrast, according to aspects of the disclosure, a number or slots 302 of k_{B} symbols is provided by radio resource control (RRC) signaling to account for the backhaul latency caused by RAR/TA forwarding from the target cell, e.g., candidate cells 204, 206 to the serving cell 202. Assuming the periodicity of the type-1-PDCCH CSS is about 20 ms, in at least one example, k_{B}=10 ms. In response to receiving the PDCCH order at the UE 200 from the servicing cell 202, the PRACH is transmitted to the one or more candidate cells 204, 206. In addition, a time gap 306 between receiving the PRACH at the UE 200 and the next type-1 PDCCH MO is less than the previous k_{B}, such that k_{B}=5 ms. In accordance with this implementation, the RAR window starts at position 304 after the PRACH is received, such that the RAR window starts at position 304 at the type-1 PDCCH MO 130. The time gap 306 after PRACH reception at the UE 200 is sufficient for RAR forwarding from target cell to serving cell 202.

Advantageously, the UE 200 does not need to monitor MO location 180, since the RAR window starts at position 304 at the MO location 130. Accordingly, less power is consumed by the UE 200 during transmission, reducing overall power requirements of the UE 200. Moreover, configuring the UE 200 as described above, reduces UE power consumption for type-1 CSS monitoring as the monitoring occasion accounts for the backhaul forwarding delay across two gNBs, e.g., candidate cells 204, 206. Another advantage is that one or more parallel RACH procedures can be triggered towards different candidate cells to minimize the signaling overhead and TA acquisition latency.

The disclosure describes how to indicate the intended TAG ID and/or candidate cell that is associated with a RAR reception at the UE 200. In one example, the UE specific search space instead of specifying common search space in order to reduce latency. Advantageously, in the current PDCCH-order CFRA procedure, a RAR is transmitted by NW in response to a PRACH reception. So far, RAR is only scheduled in type-1 CSS and cannot be scheduled using UE-specific search space, which potentially increases the scheduling latency for RAR. In addition, RAR consists of quite a few IEs that are irrelevant to LTM (local traffic manager) operation e.g., 27-bits UL grant and 16-bits C-RNTI. How to minimize the RAR signaling overhead and latency needs to be considered for LTM design.

According to other aspects of this disclosure, the timing advance group identity (ID) to apply the TA value of RAR. An RRC signal can indicate a TAG-ID for each of the one or more candidate cells 204, 206. In one implementation, a single RACH procedure is maintained at the UE 200. If a new random access (RA) procedure is triggered at the UE 200, while another is already ongoing in the MAC entity, the UE 200 determines whether to continue with the existing RAR procedure or to proceed with the new RAR procedure. In response, the UE 200 assumes the RAR is associated with the RACH procedure maintained by the UE 200.

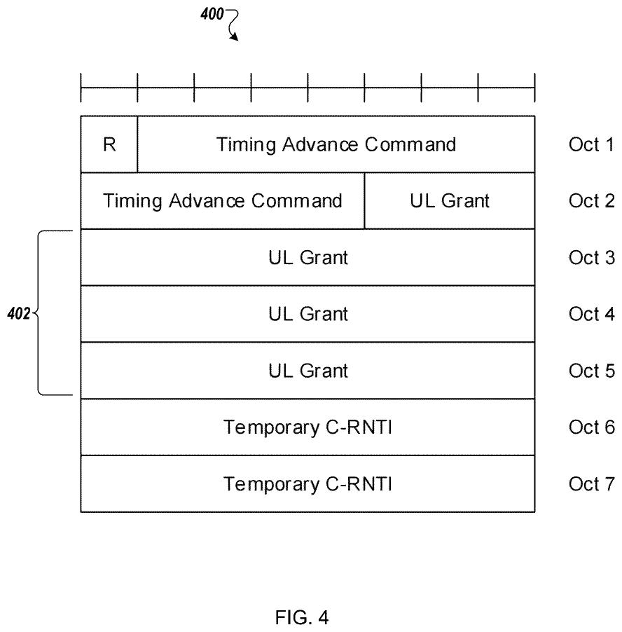

FIG. 4 illustrates a schematic for a header 400 indicating an RAR that is configured to indicate a given TAs for an associated candidate cell, such as one of candidate cells 204, 206. One or more slots 402 indicate any one of the TAG-ID, physical Cell ID, or a dedicated logic ID of one of the candidate cells 204, 206. Each TAG-ID, physical Cell ID, or a dedicated logic ID is transmitted by the UE 200, utilizing the DCI format 1_0 with CRC scrambled by RA-RNTI or by MsgB-RNTI. An RAR MAC can be utilized by the UE 200 to indicate the TAG-ID or physical cell ID (or logic ID) of the candidate cell by utilizing a ‘UL Grant’ field or a ‘Temporary C-RNTI’ field.

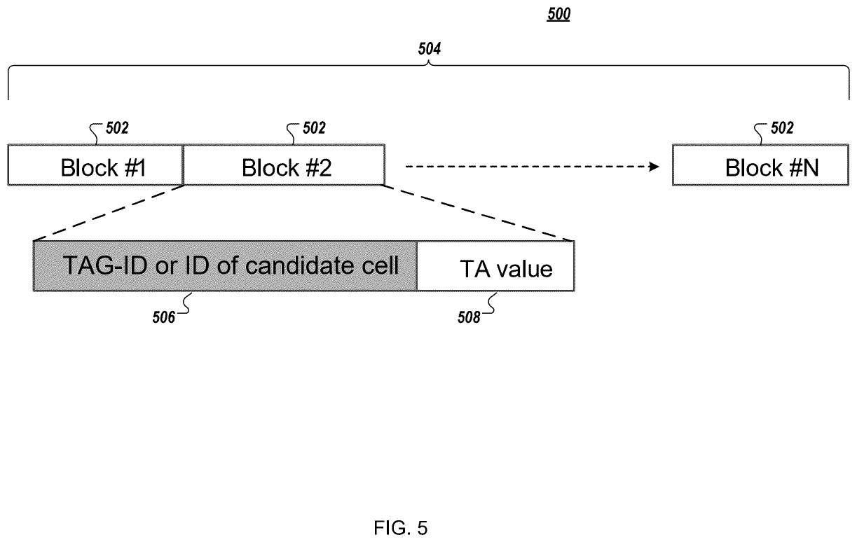

FIG. 5 shows a UE header 500 having a plurality of blocks 504 that are configured to support multiple TAs for more than one of the candidate cells 204, 206. Each of the more than one candidate cells 204, 206 can be in a single RAR MAC PDU. The plurality of blocks 504 can have between 1 and N blocks 502, where ‘N’ is a real, whole number, and is indicated by the MAC-CE sub-header. Each Block 502 within the plurality of blocks 504 includes a logic ID 506 and a TA value 508. The logic ID 506 can be any one of a configuration ID or TAG-ID that is associated with one of the candidate cells 204, 206. The candidate cell(s) 204, 206 is triggered by a PRACH transmission, in response to a PDCCH-order received at the UE 200, as described above, and shown in FIG. 2.

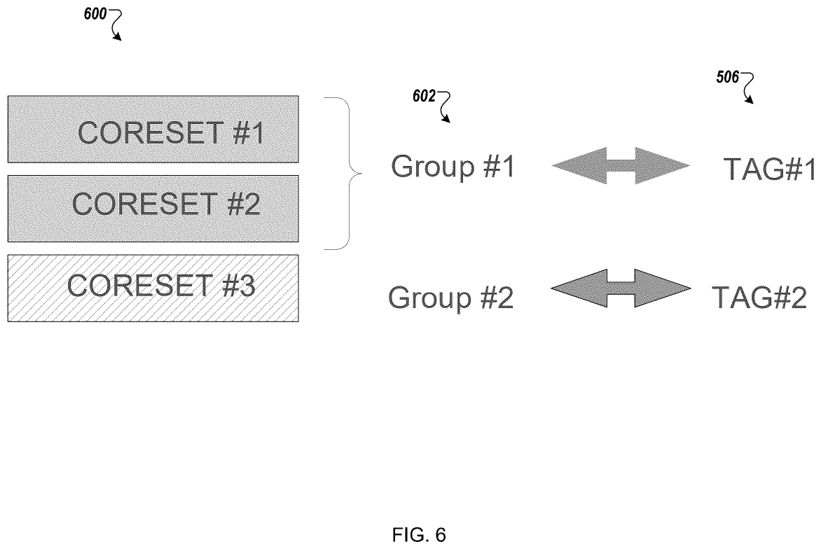

FIG. 6 illustrates a schematic for a plurality of CORESET groups 600 having corresponding TAG-IDs 506. In some implementations, radio resource control (RRC) signaling can be used to divide the CORESETs into a unique group 602. Each group 602 can be associated the logic ID 506. Thus, in some implementations, each group 602, and the corresponding CORESET(s) are associated with a given TAG-ID, as shown in FIG. 6. If the UE 200 receives a radio access response (RAR) physical downlink shared channel (PDSCH) that is scheduled by a CORESET with a CORESET group index value, the UE 200 assumes that the TAG-ID associated with the CORESET group index is updated by the scheduled RAR.

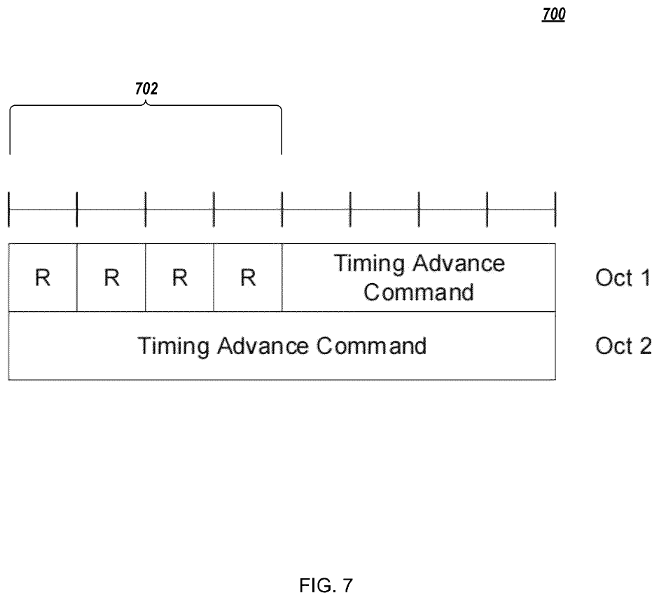

FIG. 7 illustrates a header 700 of a TA command for indicating a TAG-ID. In some examples, the TA command can be a MAC-CE. According to aspects of this disclosure, a CFRA procedure is introduced for two TAs in a multi-downlink control information (mDCI) multi-transmission reception point (mTRP) transmission. The header 700 designates ‘R’ fields 702 for a a TAG-ID or logic ID of the candidate cell 204, 206. The TA command MAC-CE is identified by a MAC subheader with a dedicated extended logic channel ID (eLCID) that is hard-encoded specification. The eLCID has a fixed size, e.g., two Octet.

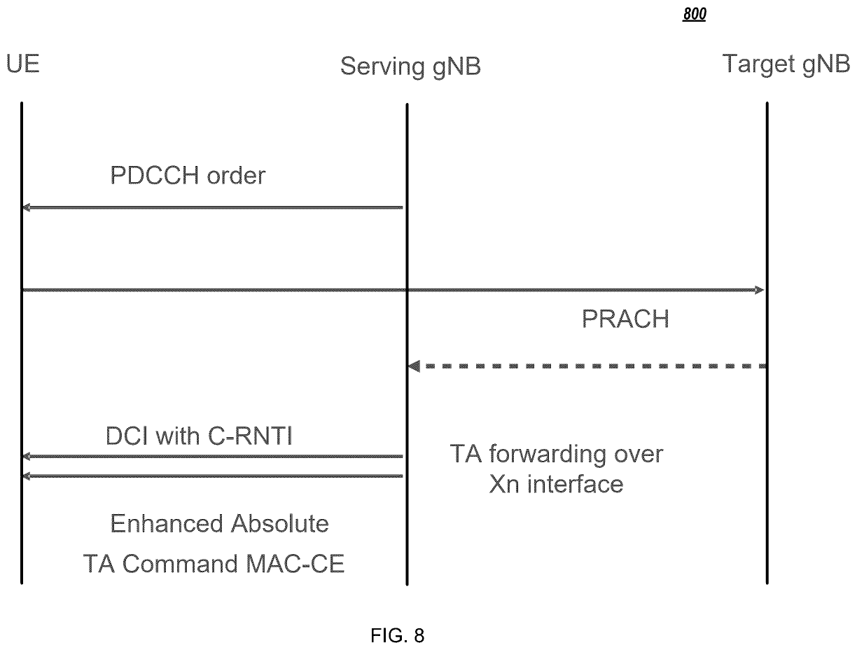

FIG. 8 illustrates a process 800 for a RACH procedure for obtaining one or more TAs at the UE 200. The process 800 provides for an overall enhanced CFRA procedure to obtain TA for the target TRP/cell The process 800 includes at least two operations. In a first operation, in response to a PRACH transmission from a UE to a target gNb, the UE generates signals to detect a DCI format 1_0 with CRC scrambled by a C-RNTI during a RAR window controlled by NW. In the second operation, the MAC PDU, scheduled by the DCI format 1_0, includes the TA command MAC-CE that is associated with a target candidate cell or target TRP. In some implementations, the TA command MAC-CE can be received via the serving gNb. In one implementation, if only one RACH procedure is maintained, the TA command MAC-CE is used, and thus scheduled by a C-RNTI from any search spaces, received at the UE from the serving gNb. In some implementations, the UE can be the UE 200, the serving gNb can be the serving cell 202, and the target gNb can be either one of the candidate cells 204, 206, as shown in FIG. 2

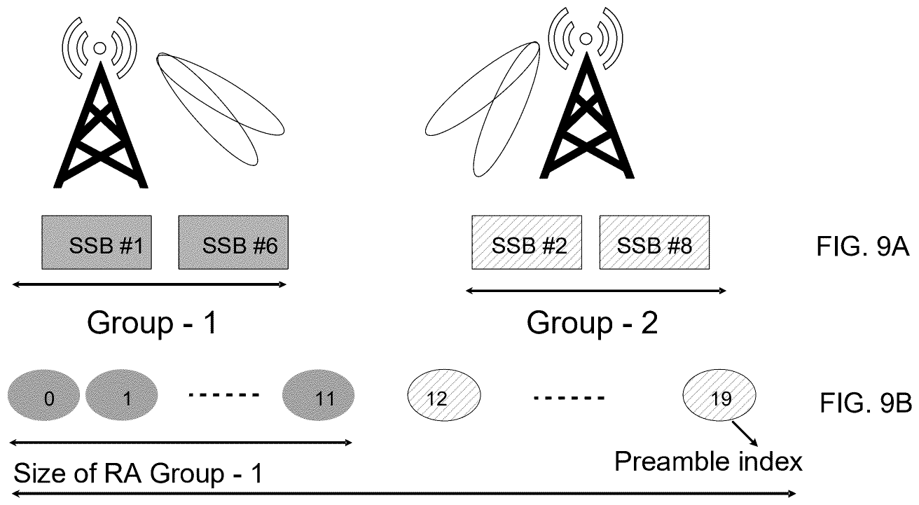

FIGS. 9A-9B illustrate a schematic of a mechanism to enable two TAs for intra-cell intra-cell multi-transmission reception point (mTRP) transmission. According to certain aspects of this disclosure, for an intra-cell multi-transmission reception point (mTRP) scenario, the disclosed subject matter supports a contentions-based RACH (CBRA) procedure to obtain the TA for the second TRP. In one first implementation, the SSBs indicated by ssb-PositionsInBurst may be divided into two different groups, e.g., synchronization signal block (SSB) group 1 and SSB group 2. The SSB grouping configuration can be provided by SIB information or UE-dedicated RRC message. For intra-cell CBRA procedure, the UE 200 selects a PRACH resource associated with an SSB in a SSB group ‘k’ that is distinct from the SSB group that includes a SSB associated with the active TCI-state. In the first implementation, depicted in FIG. 9A, the 4 SSBs are divided into two groups, where group 1 includes of SSB {1,6} and group 2 includes of SSB {2,8}. The SSB groups are based on the information provided by SIB or dedicated RRC signaling.

In a second implementation, the PRACH resources can be divided into two groups, e.g., group 1 and group 2. In some implementations, a parameter, e.g., ‘sizeofRA-Group1,’ can be introduced for each PRACH resource occasion (RO). For example, each of the preambles in group 1 include range of preambles 0, i.e., preamble 0 to a designated size, e.g., parameter, ‘sizeofRA-Group1.’ The remaining preambles are associated with group 2. A UE is explicitly configured by RRC designating which PRACH group e.g., group-1 or Group-2, for the CBRA procedure to obtain the second TA. In some implementations, there may be a total of 20 preambles in an RO. For example, in the second implementation, the total of 20 preambles are split into two groups (e.g., group 1, group 2) and the sizeofRA-Group1 is set to be ‘12’. Accordingly, group-1 would include preambles {0˜11} and the remaining preambles is in group-2.

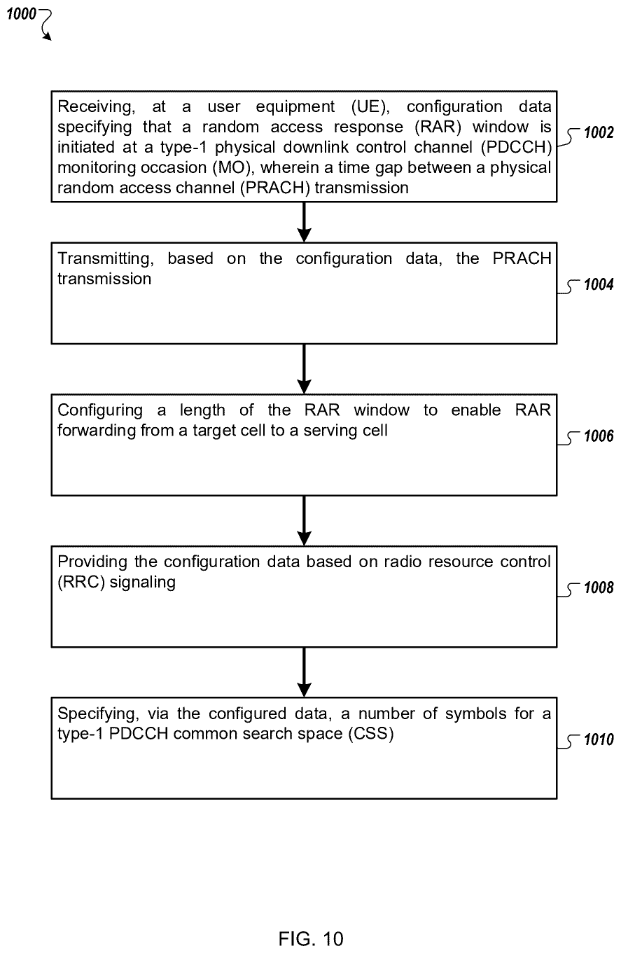

FIG. 10 illustrates a flowchart of an example method 1000, according to some implementations. For clarity of presentation, the description that follows generally describes method 1000 in the context of the other figures in this description. For example, method 1000 can be performed by the UE 200 of FIG. 2.

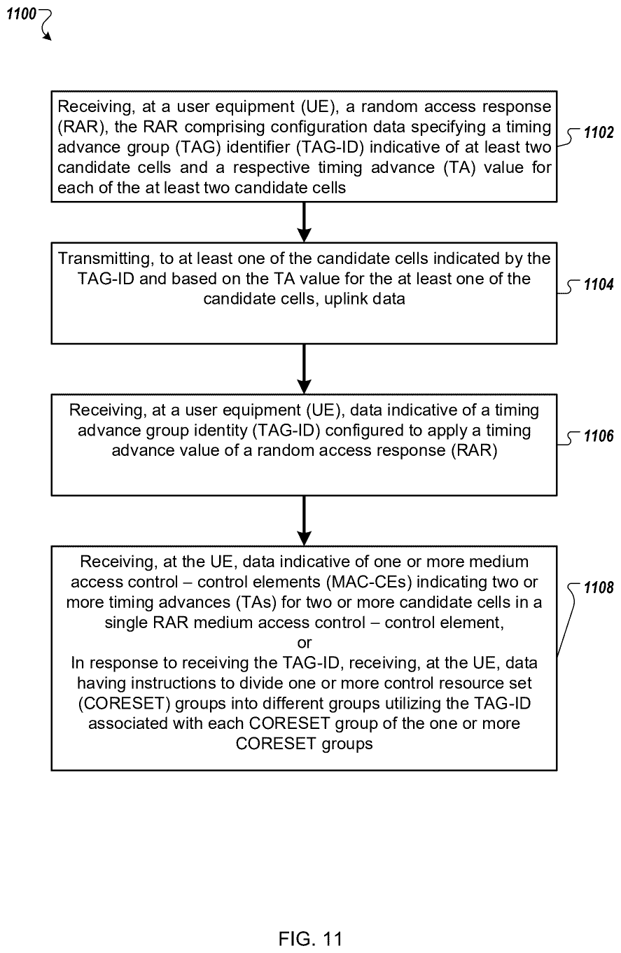

FIG. 11 illustrates a flowchart of an example method 1100, according to some implementations. For clarity of presentation, the description that follows generally describes method 1000 in the context of the other figures in this description. For example, method 1100 can be performed by the UE 200 of FIG. 2. The method 1100 includes operations 1102, 1104, 1106, and 1108. In some implementations, the method proceeds at operation 1106, by receiving, at a user equipment (UE), data indicative of a timing advance group identity (TAG-ID) configured to apply a timing advance value of a random access response (RAR). At operation 1108, the method 1100 can proceed at operation 1108 by receiving, at the UE, data indicative of one or more medium access control-control elements (MAC-CEs) indicating two or more timing advances (TAs) for two or more candidate cells in a single RAR medium access control-control element. Alternatively, at operation 1108, the method 1100 can proceed, in response to receiving the TAG-ID, receiving, at the UE, data having instructions to divide one or more control resource set (CORESET) groups into different groups utilizing the TAG-ID associated with each CORESET group of the one or more CORESET groups.

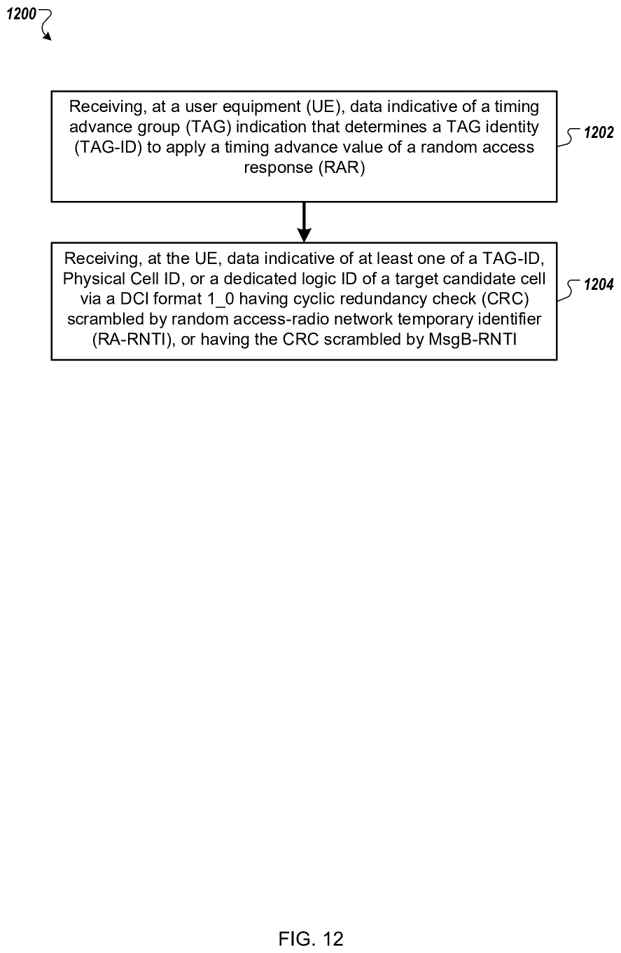

FIG. 12 illustrates a flowchart of an example method 1200, according to some implementations. For clarity of presentation, the description that follows generally describes method 1000 in the context of the other figures in this description. For example, method 1200, which includes operation 1202 and 1204, can be performed by the UE 200 of FIG. 2.

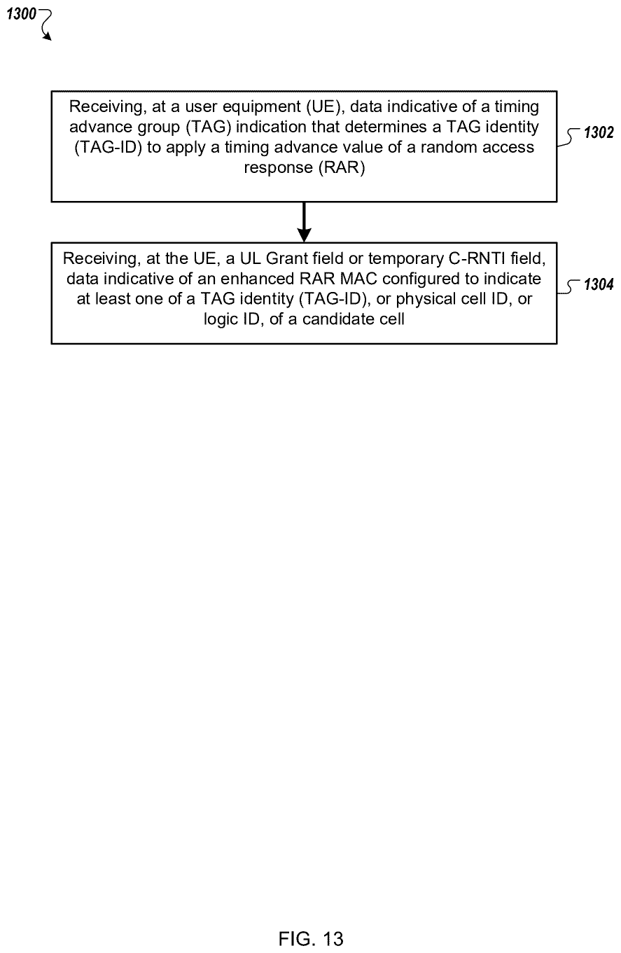

FIG. 13 illustrates a flowchart of an example method 1300, according to some implementations. For clarity of presentation, the description that follows generally describes method 1000 in the context of the other figures in this description. For example, method 1300, which includes operation 1302 and 1304, can be performed by the UE 200 of FIG. 2.

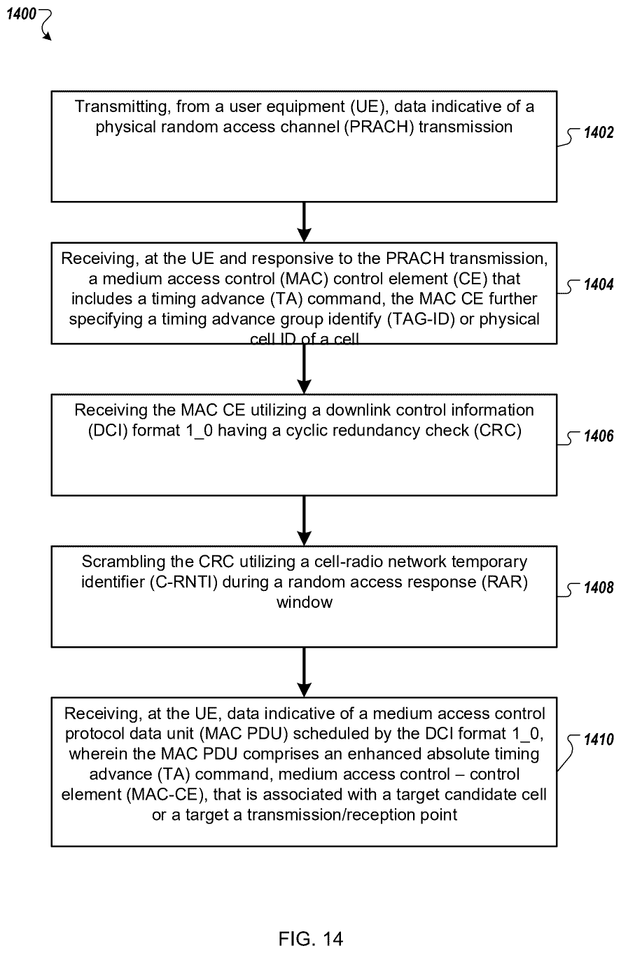

FIG. 14 illustrates a flowchart of an example method 1400, according to some implementations. For clarity of presentation, the description that follows generally describes method 1000 in the context of the other figures in this description. For example, method 1400 can be performed by the UE 200 of FIG. 2. The method 1400 can include operations 1402, 1404, 1406, 1408, and 1410. In some implementations of the method 1400, (e.g., operation 1406), the MAC CE is received based on a downlink control information (DCI) format 1_0 having a cyclic redundancy check (CRC).

In another implementation of the method 1400, the CRC is scrambled (e.g., operation 1408) by a cell-radio network temporary identifier (C-RNTI) during a random access response (RAR) window. In yet another implementation, the method 1400 can proceed by receiving, at the UE (e.g., operation 1410), data indicative of a medium access control protocol data unit (MAC PDU) scheduled by the DCI format 1_0, wherein the MAC PDU comprises an enhanced absolute timing advance (TA) command, medium access control-control element (MAC-CE), that is associated with a target candidate cell or a target a transmission/reception point (TRP).

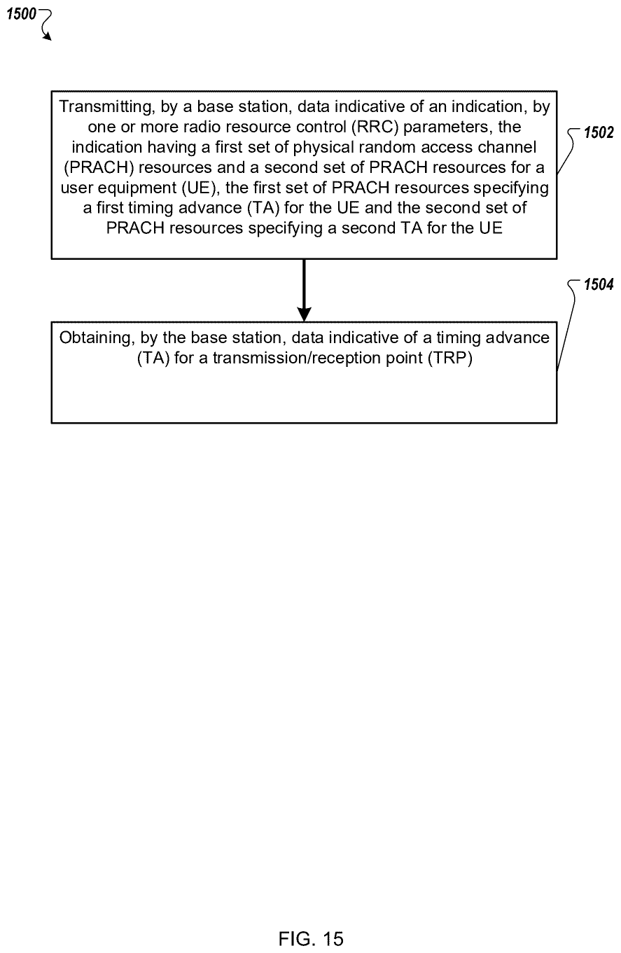

FIG. 15 illustrates a flowchart of an example method 1500, according to some implementations. For clarity of presentation, the description that follows generally describes method 1000 in the context of the other figures in this description. For example, method 1500, which includes operations 1502 and 1504, can be performed by the serving cell 202 or candidate cells 204, 206 shown in FIG. 2. In some implementations of the method 1500, the first set of PRACH resources include a first synchronization signal block (SSB) group and a second SSB group, wherein a grouping configuration of the SSB is provided by one or more of a system information block (SIB) information or a radio resource control (RRC) message. In another implementation of the method 1500, the first set of PRACH resources include a first set of preambles and wherein the second set of PRACH resources include a second set of preambles.

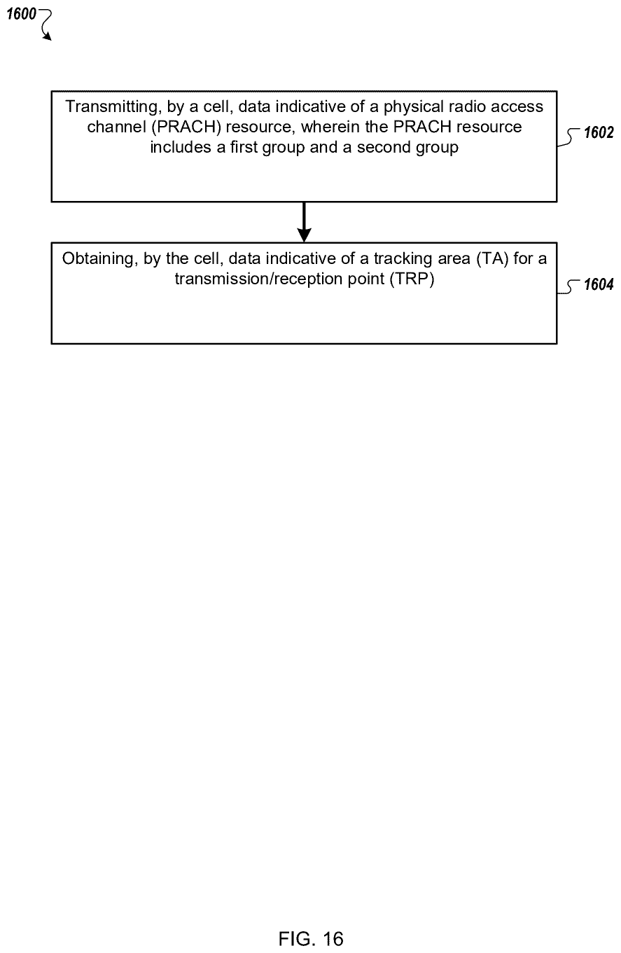

FIG. 16 illustrates a flowchart of an example method 1600, according to some implementations. For clarity of presentation, the description that follows generally describes method 1600 in the context of the other figures in this description. For example, method 1600, which includes operations 1602 and 1604, can be performed by the serving cell 202 or candidate cells 204, 206 shown in FIG. 2.

It will be understood that each of methods 1000-1600 can be performed individually, or in combination, for example, by any suitable system, environment, software, hardware, or a combination of systems, environments, software, and hardware, as appropriate. In some implementations, various steps of method 1000 can be run in parallel, in combination, in loops, or in any order.

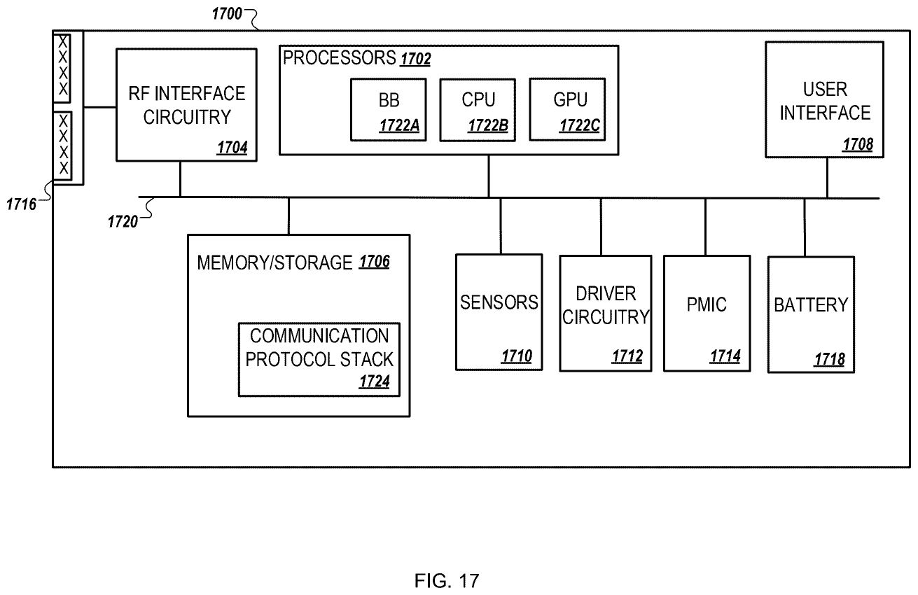

FIG. 17 illustrates an example UE 1700, according to some implementations. The UE 1700 may be similar to and substantially interchangeable with UE 102 of FIG. 1.

The UE 1700 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1700 may include processors 1702, RF interface circuitry 1704, memory/storage 1706, user interface 1708, sensors 1710, driver circuitry 1712, power management integrated circuit (PMIC) 1714, one or more antenna(s) 1716, and battery 1718. The components of the UE 1700 may be implemented as integrated circuits (ICs), portions thereof, discrete electronic devices, or other modules, logic, hardware, software, firmware, or a combination thereof. The block diagram of FIG. 17 is intended to show a high-level view of some of the components of the UE 1700. However, some of the components shown may be omitted, additional components may be present, and different arrangement of the components shown may occur in other implementations.

The components of the UE 1700 may be coupled with various other components over one or more interconnects 1720, which may represent any type of interface, input/output, bus (local, system, or expansion), transmission line, trace, optical connection, etc. that allows various circuit components (on common or different chips or chipsets) to interact with one another.

The processors 1702 may include processor circuitry such as, for example, baseband processor circuitry (BB) 1722A, central processor unit circuitry (CPU) 1722B, and graphics processor unit circuitry (GPU) 1722C. The processors 1702 may include any type of circuitry or processor circuitry that executes or otherwise operates computer-executable instructions, such as program code, software modules, or functional processes from memory/storage 1706 to cause the UE 1700 to perform operations as described herein.

In some implementations, the baseband processor circuitry 1722A may access a communication protocol stack 1724 in the memory/storage 1706 to communicate over a 3GPP compatible network. In general, the baseband processor circuitry 1722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1704. The baseband processor circuitry 1722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1706 may include one or more non-transitory, computer-readable media that includes instructions (for example, communication protocol stack 1724) that may be executed by one or more of the processors 1702 to cause the UE 1700 to perform various operations described herein. The memory/storage 1706 include any type of volatile or non-volatile memory that may be distributed throughout the UE 1700. In some implementations, some of the memory/storage 1706 may be located on the processors 1702 themselves (for example, L1 and L2 cache), while other memory/storage 1706 is external to the processors 1702 but accessible thereto via a memory interface. The memory/storage 1706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1704 may include transceiver circuitry and radio frequency front module (RFEM) that allows the UE 1700 to communicate with other devices over a radio access network. The RF interface circuitry 1704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1716 and proceed to filter and amplify (with a low-noise amplifier) the signal. The signal may be provided to a receiver of the transceiver that downconverts the RF signal into a baseband signal that is provided to the baseband processor of the processors 1702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1716. In various implementations, the RF interface circuitry 1704 may be configured to transmit/receive signals in a manner compatible with NR access technologies.

The antenna(s) 1716 may include one or more antenna elements to convert electrical signals into radio waves to travel through the air and to convert received radio waves into electrical signals. The antenna elements may be arranged into one or more antenna panels. The antenna(s) 1716 may have antenna panels that are omnidirectional, directional, or a combination thereof to enable beamforming and multiple input, multiple output communications. The antenna(s) 1716 may include microstrip antennas, printed antennas fabricated on the surface of one or more printed circuit boards, patch antennas, phased array antennas, etc. The antenna(s) 1716 may have one or more panels designed for specific frequency bands including bands in FR1 or FR2.

The user interface 1708 includes various input/output (I/O) devices designed to enable user interaction with the UE 1700. The user interface 1708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1700.

The sensors 1710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1712 may include software and hardware elements that operate to control particular devices that are embedded in the UE 1700, attached to the UE 1700, or otherwise communicatively coupled with the UE 1700. The driver circuitry 1712 may include individual drivers allowing other components to interact with or control various input/output (I/O) devices that may be present within, or connected to, the UE 1700. For example, driver circuitry 1712 may include a display driver to control and allow access to a display device, a touchscreen driver to control and allow access to a touchscreen interface, sensor drivers to obtain sensor readings of sensors 1710 and control and allow access to sensors 1710, drivers to obtain actuator positions of electro-mechanic components or control and allow access to the electro-mechanic components, a camera driver to control and allow access to an embedded image capture device, audio drivers to control and allow access to one or more audio devices.

The PMIC 1714 may manage power provided to various components of the UE 1700. In particular, with respect to the processors 1702, the PMIC 1714 may control power-source selection, voltage scaling, battery charging, or DC-to-DC conversion.

In some implementations, the PMIC 1714 may control, or otherwise be part of, various power saving mechanisms of the UE 1700. A battery 1718 may power the UE 1700, although in some examples the UE 1700 may be mounted deployed in a fixed location, and may have a power supply coupled to an electrical grid. The battery 1718 may be a lithium ion battery, a metal-air battery, such as a zinc-air battery, an aluminum-air battery, a lithium-air battery, and the like. In some implementations, such as in vehicle-based applications, the battery 1718 may be a typical lead-acid automotive battery.

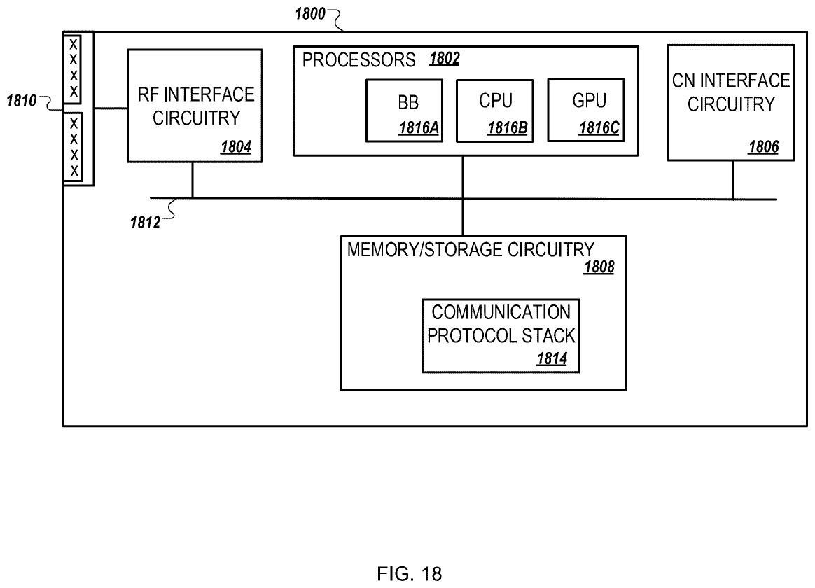

FIG. 18 illustrates an example access node 1800 (e.g., a base station or gNB), according to some implementations. The access node 1800 may be similar to and substantially interchangeable with base station 104. The access node 1800 may include processors 1802, RF interface circuitry 1804, core network (CN) interface circuitry 1806, memory/storage circuitry 1808, and one or more antenna(s) 1810.

The components of the access node 1800 may be coupled with various other components over one or more interconnects 1812. The processors 1802, RF interface circuitry 1804, memory/storage circuitry 1808 (including communication protocol stack 1814), antenna(s) 1810, and interconnects 1812 may be similar to like-named elements shown and described with respect to FIG. 17. For example, the processors 1802 may include processor circuitry such as, for example, baseband processor circuitry (BB) 1816A, central processor unit circuitry (CPU) 1816B, and graphics processor unit circuitry (GPU) 1816C.

The CN interface circuitry 1806 may provide connectivity to a core network, for example, a 5th Generation Core network (5GC) using a 5GC-compatible network interface protocol such as carrier Ethernet protocols, or some other suitable protocol. Network connectivity may be provided to/from the access node 1800 via a fiber optic or wireless backhaul. The CN interface circuitry 1806 may include one or more dedicated processors or FPGAs to communicate using one or more of the aforementioned protocols. In some implementations, the CN interface circuitry 1806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1800 that operates in an NR or 5G system (for example, a gNB), and the term “E-UTRAN node” or the like may refer to an access node 1800 that operates in an LTE or 4G system (e.g., an eNB). According to various implementations, the access node 1800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1800 may be implemented as one or more software entities running on server computers as part of a virtual network, which may be referred to as a CRAN and/or a virtual baseband unit pool (vBBUP). In V2X scenarios, the access node 1800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 172(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of examples 1-6.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

1. A method comprising:
decoding configuration data specifying that a random access response (RAR) window that is started at a first symbol of an earliest type-1 physical downlink control channel (PDCCH) monitoring occasion (MO), wherein a time gap between a physical random access channel (PRACH) transmission and the earlier type-1 PDCCH MO is at least ‘k_{B}’ symbols or slots or milliseconds;
encoding, based on the configuration data, the PRACH transmission; and
monitoring, within the RAR window specified by the configuration, each type-1 PDCCH MOs for RAR reception in response to the PRACH transmission.

2. The method of claim 1, wherein gap with a length of ‘k_{B}’ symbols or slots or milliseconds between PRACH transmission and the associated RAR window is determined based on the RAR forwarding latency from a target candidate cell to a serving cell.

3. The method of claim 1, wherein the configuration data is provided based on radio resource control (RRC) signaling.

4. The method of claim 1, wherein the configured data specify a gap with a length of number of ‘k_{B}’ symbols or slots or milliseconds between the PRACH transmission and an earliest type-1 PDCCH common search space (CSS) within the RAR window.

5. The method of claim 1, comprising:
decoding a random access response (RAR), the RAR comprising configuration data specifying a timing advance group (TAG) identifier (TAG-ID) indicative of at least two candidate cells and a respective timing advance (TA) value for the TAG that is identified by the TAG-ID;
encoding uplink signaling for transmission to at least one of the candidate cells associated with the TAG-ID based on the TA value of the TAG corresponding to the TAG-ID.

6. The method of claim 5, comprising:
decoding data indicative of a timing advance group identity (TAG-ID) for a candidate cell to indicate a timing advance value for uplink transmission on the candidate cell; and
decoding one or more medium access control elements (MAC-CEs) in a single RAR Protocol Data Unit (PDU), each MAC-CE indicating a timing advance (TA) and the associated TAG-ID.

7. The method of claim 5, comprising:
decoding a timing advance group identity (TAG-ID) configured to apply a timing advance value of a random access response (RAR); and
in response to receiving the TAG-ID, encoding data having instructions to divide one or more control resource set (CORESET) groups into different groups utilizing the TAG-ID associated with each CORESET group of the one or more CORESET groups.

8. The method of claim 1, comprising:
decoding data indicative of a timing advance group identity (TAG-ID) for a candidate cell to indicate a timing advance value for uplink transmission on the candidate cell; and
decoding data indicative of at least one of a TAG-ID, Physical Cell ID, or a dedicated logic ID of a target candidate cell via a DCI format 1_0 having cyclic redundancy check (CRC) scrambled by random access-radio network temporary identifier (RA-RNTI), or having the CRC scrambled by MsgB-RNTI where the DCI format 1_0 consists of one field indicating a TAG-ID or Physical Cell ID or a dedicated logic ID of a target candidate cell.

9. The method of claim 1, comprising:
decoding data indicative of a timing advance group (TAG) for a candidate cell to apply a timing advance value of a random access response (RAR); and
decoding an enhanced RAR MAC repurposing a UL Grant field or temporary C-RNTI field to indicate at least one of a TAG identity (TAG-ID), or physical cell ID, or logic ID, of a candidate cell.

10. The method of claim 1, comprising:
encoding, data indicative of a physical random access channel (PRACH) transmission; and
decoding and responsive to the PRACH transmission, a medium access control (MAC) control element (CE) that includes a timing advance (TA) command, the MAC-CE further specifying a timing advance group identify (TAG-ID) or physical cell ID of a candidate cell to apply the TA value indicated by the TA command of the MAC-CE.

11. The method of claim 10, wherein the MAC-CE is scheduled by a downlink control information (DCI) format 1_0 having a cyclic redundancy check (CRC).

12. The method of claim 11, wherein the CRC bits of a DCI format 1_0 is scrambled by a cell-radio network temporary identifier (C-RNTI) during a random access response (RAR) window.

13. The method of claim 10 comprising:
decoding a medium access control protocol data unit (MAC PDU) scheduled by a DCI format 1_0, wherein the MAC PDU comprises an enhanced absolute timing advance (TA) command medium access control-control element (MAC-CE) comprising an information field that indicates the TAG-ID or logic ID that is associated with a target candidate cell or a target a transmission/reception point (TRP).

14. The method of claim 1, comprising:
encoding one or more radio resource control (RRC) parameters; and
encoding a first set of physical random access channel (PRACH) resources and a second set of PRACH resources, the first set of PRACH resources are used to obtain a first timing advance (TA) associated with a first TAG-ID and the second set of PRACH resources are used to obtain a second TA associated with a second TAG-ID.

15. The method of claim 14, wherein the first set of PRACH resources are associated with a first synchronization signal block (SSB) group and a second set of PRACH resources are associated with a second SSB group, wherein a SSB grouping configuration is provided by one or more of a system information block (SIB) information or a radio resource control (RRC) message.

16. The method of claim 14, wherein the first set of PRACH resources include a first set of preambles and wherein the second set of PRACH resources include a second set of preambles.

17. (canceled)

18. A non-transitory computer storage medium encoded with instructions that, when executed by one or more computers, cause the one or more computers to perform operations comprising:
decoding configuration data specifying that a random access response (RAR) window that is started at a first symbol of an earliest type-1 physical downlink control channel (PDCCH) monitoring occasion (MO), wherein a time gap between a physical random access channel (PRACH) transmission and the earlier type-1 PDCCH MO is at least ‘k_{B}’ symbols or slots or milliseconds;
encoding, based on the configuration data, the PRACH transmission; and
monitoring, within the RAR window specified by the configuration, each type-1 PDCCH MOs for RAR reception in response to the PRACH transmission.

19. A system comprising one or more processors and one or more storage devices on which are stored instructions that are operable, when executed by the one or more processors, to cause the one or more processors to perform operations comprising:
decoding configuration data specifying that a random access response (RAR) window that is started at a first symbol of an earliest type-1 physical downlink control channel (PDCCH) monitoring occasion (MO), wherein a time gap between a physical random access channel (PRACH) transmission and the earlier type-1 PDCCH MO is at least ‘k_{B}’ symbols or slots or milliseconds;
encoding, based on the configuration data, the PRACH transmission; and
monitoring, within the RAR window specified by the configuration, each type-1 PDCCH MOs for RAR reception in response to the PRACH transmission.

20-26. (canceled)

27. The non-transitory computer storage medium of claim 18, wherein gap with a length of ‘k_{B}’ symbols or slots or milliseconds between PRACH transmission and the associated RAR window is determined based on the RAR forwarding latency from a target candidate cell to a serving cell.

28. The system of claim 19, wherein gap with a length of ‘k_{B}’ symbols or slots or milliseconds between PRACH transmission and the associated RAR window is determined based on the RAR forwarding latency from a target candidate cell to a serving cell.
